(19) United States
(12) Patent Application Publication
(10) Pub. No.: US 2013/0096031 A1
(43) Pub. Date: Apr. 18, 2013

(54) MICROFLUIDIC CHIP

(71) Applicant: Chin-Feng Wan, Hsinchu City (TW)

(72) Inventor: Chin-Feng Wan, Hsinchu City (TW)

(21) Appl. No.: 13/632,784

(22) Filed: Oct. 1, 2012

(30) Foreign Application Priority Data
Oct. 13, 2011 (TW) 100219167

(51) Int. Cl. C40B 40/06; C40B 40/10

(52) U.S. Cl. 506/16; 506/18

(57) ABSTRACT

A microfluidic chip includes a base layer, a fluid layer, and a gas regulating layer. The base layer includes a microarray detecting zone. The microarray detecting zone includes a substrate, a photoresist pattern layer, a blocking layer, a bonding layer, at least one linker molecule, and a probe molecule. The bonding layer is covalently attached to the photoresist pattern layer. The at least one linker molecule is covalently bonded to the binding layer. The probe molecule is covalently bonded to the at least one linker molecule for specifically reacting with an under-test molecule. The fluid layer is disposed over the base layer, and includes plural flow channels for introducing or collecting detecting reagents. The gas regulating layer is disposed over the fluid layer for controlling open/close statuses of the flow channels, thereby controlling a flowing condition of a fluid in the fluid layer.

### FIELD OF THE INVENTION

The present invention relates to a biochip, and more particularly to a microfluidic chip.

### BACKGROUND OF THE INVENTION

A biochip is a miniaturized device that allows specific biochemical reactions between specified biological materials (e.g. nucleic acid or protein) and other under-test biological samples by employing a microelectromechanical systems (MEMS) technology. After the reaction signals are quantified by various sensors, the possible biochemical reactions can be realized. In other words, the miniaturized device fabricated by a microelectromechanical technology and a biological technology is referred as the biochip. For example, the biochip is a microfluidic chip or a lab-on-a-chip. The applications of the biochip cover the disease diagnosis, the gene probe, the pharmaceutical technology, the microelectronic technology, the semiconductor technology, the computer technology, and the like.

Recently, due to the rapid development of the biomedical and the rising awareness of personal health, the demands on fast symptom detection and correct diagnosis are gradually increased. The medical organizations or research organizations pay much attention on seeking the platform for automatically and quickly acquire large numbers of detection data. With the development and maturity of the microelectromechanical systems technology, the microfluidic chip becomes a rapidly developing research field. By means of the microelectromechanical systems technology, a series of steps of carrying out the complicated biological reaction (e.g. sampling, sample handling, sample separation, reagent reaction and detection) can be integrated into a small microfluidic chip. In other words, the microfluidic chip has many benefits such as low cost, rapid detection and low reagent and sample consumption.

However, the conventional microfluidic chip still has some drawbacks. For example, after a photoresist pattern layer is formed on a substrate, the surface of the photoresist pattern layer is directly connected with a biological material in order to detect the under-test molecule. Since the adhesion between the biological material and the photoresist material is insufficient, the detecting precision and stability of the conventional microfluidic chip are usually unsatisfied.

Therefore, there is a need of providing an improved microfluidic chip so as to obviate the above drawbacks.

### SUMMARY OF THE INVENTION

The present invention provides a microfluidic chip with enhanced precision and stability, so that applications of the microfluidic chip are more expansive.

In accordance with an aspect of the present invention, there is provided a microfluidic chip. The microfluidic chip includes a base layer, a fluid layer, and a gas regulating layer. The base layer includes a microarray detecting zone. The microarray detecting zone includes a substrate, a photoresist pattern layer, a blocking layer, a bonding layer, at least one linker molecule, and a probe molecule. The photoresist pattern layer is formed on a surface of the substrate. The blocking layer is formed on the surface of the substrate at a region uncovered by the photoresist pattern layer. The bonding layer is covalently attached to the photoresist pattern layer. The at least one linker molecule is covalently bonded to the binding layer. The probe molecule is covalently bonded to the at least one linker molecule for specifically reacting with an under-test molecule. The fluid layer is disposed over the base layer, and includes plural flow channels for introducing or collecting detecting reagents. The gas regulating layer is disposed over the fluid layer for controlling open/close statuses of the flow channels, thereby controlling a flowing condition of a fluid in the fluid layer.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic view illustrating the structure of a microfluidic chip according to an embodiment of the present invention;

FIG. 2 is a schematic view illustrating the microarray detecting zone of the base layer of a microfluidic chip according to an embodiment of the present invention; and

FIG. 3 schematically illustrates the relationships between the fluid layer and the gas regulating layer of the microfluidic chip according to the embodiment of the present invention, in which the gas regulating layer is disposed over the fluid layer.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

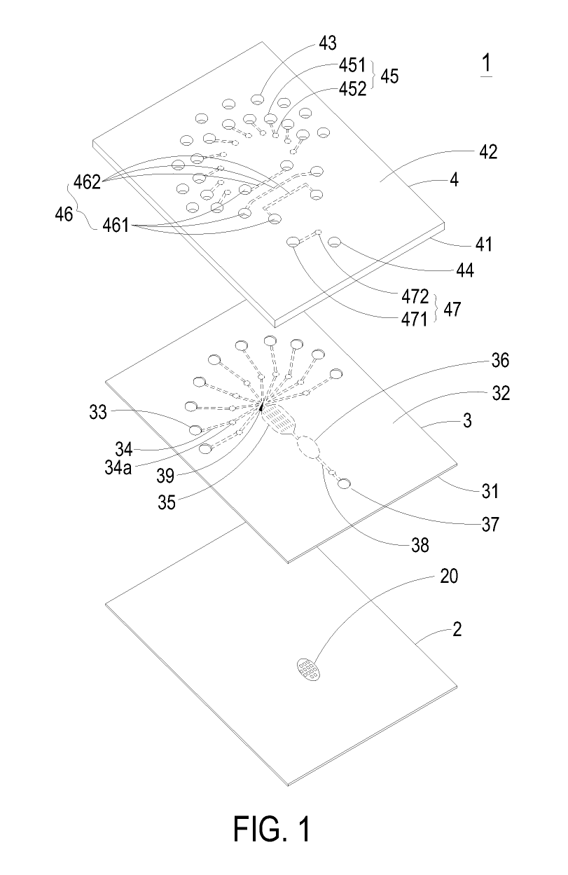

FIG. 1 is a schematic view illustrating the structure of a microfluidic chip according to an embodiment of the present invention. As shown in FIG. 1, the microfluidic chip 1 comprises a base layer 2, a fluid layer 3, and a gas regulating layer 4. The base layer 2 has a microarray detecting zone 20. The fluid layer 3 is disposed over the base layer 2 to cover the base layer 2. The fluid layer 3 has flow channels, wherein samples and detecting reagents may be introduced into or collected in the flow channels. The gas regulating layer 4 is disposed over the fluid layer 3 to cover the fluid layer 3. The gas regulating layer 4 is used for controlling the open/close statuses of the flow channels in order to control the flowing condition of the fluid in the fluid layer 3.

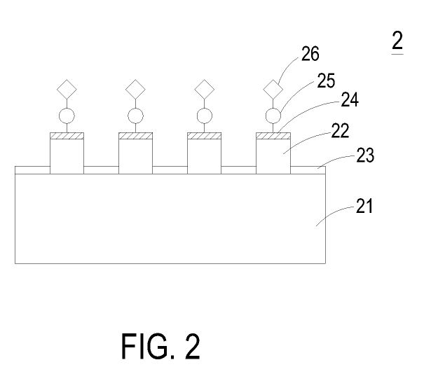

FIG. 2 is a schematic view illustrating the microarray detecting zone of the base layer of a microfluidic chip according to an embodiment of the present invention. As shown in FIG. 2, the microarray detecting zone 20 of the base layer 2 comprises a substrate 21, a photoresist pattern layer 22, a blocking layer 23, a bonding layer 24, a linker molecule 25, and a probe molecule 26. The photoresist pattern layer 22 is formed on a surface of the substrate 21. The blocking layer 23 is formed on the surface of the substrate 21 at the region uncovered by the photoresist pattern layer 22. The bonding layer 24 is covalently attached to the photoresist pattern layer 22. The linker molecule 25 is covalently bonded to the binding layer 24. The probe molecule 26 is covalently bonded to the linker molecule 25 for specifically reacting with an under-test molecule.

The substrate 21 is for example a glass substrate, a silicon chip substrate, or a plastic substrate or a polymeric substrate.

The photoresist pattern layer 22 is made of a SU-8 photoresist material. The photoresist pattern layer 22 is employed to define a microarray structure. Each spot of the microarray structure has a diameter of about 10˜300 μm. Preferably, the photoresist pattern layer 22 is produced by a maskless lithography process.

Preferably, the blocking layer 23 is made of dimethyldichlorosilane. The surface of the blocking layer 23 has no functional groups. The blocking layer 23 may block the under-test molecule from being attached thereon through a non-specific reaction. Consequently, the subsequent biological detecting reactions may precisely occur at the microarray structure, which is defined by the photoresist pattern layer 22.

Preferably, the bonding layer 24 is made of 3-[Bis(2-hydroxyethyl)amino] propyl-triethoxysilane. Moreover, the bonding layer 24 has hydroxyl groups as active functional groups. Consequently, the bonding layer 24 may be connected with the linker molecule 25 via the bonding layer 24.

Preferably, the linker molecule 25 is made of 1,4-phenylene diisothiocyanate. An isocyanate group of the linker molecule 25 may be connected with the active functional group of the binding layer 24, and another isocyanate group of the linker molecule 25 may be connected with the active functional group of the probe molecule 26 (e.g. the N-terminal amino group of a protein molecule).

Depending on the biological detection target, the probe molecule 26 may be a nucleic acid or a protein. Consequently, the probe molecule 26 may be used in genetic testing, antibody-antigen reaction detection, enzyme-substrate reaction detection, receptor-ligand reaction detection, aptamer-target reaction detection, cellular reaction detection or protein-protein reaction detection. In other words, the biologic molecule capable of specifically reacting with the under-test molecule may be served as the probe molecule 26.

Please refer to FIG. 1 again. The fluid layer 3 is made of polydimethyl siloxane (PDMS). The fluid layer 3 has a first surface 31 facing the base layer 2 and a second surface 32 facing the gas regulating layer 4. Moreover, the fluid layer 3 comprises plural solution inlets 33, plural micro channels 34, a buffer region 39, a diffluent region 35, a reactive region 36, and a solution outlet 37. The plural solution inlets 33 are formed in the second surface 32 of the fluid layer 3. The samples, reagents and clearing solutions may be introduced into the fluid layer 3 through different solution inlets 33. The plural micro channels 34 are concavely formed in the first surface 31 of the fluid layer 3. In addition, the plural micro channels 34 are in communication with and arranged between the plural solution inlets 33 and the buffer region 39. The buffer region 39, the diffluent region 35 and the reactive region 36 are also concavely formed in the first surface 31 of the fluid layer 3. In addition, the buffer region 39 and the diffluent region 35 are in communication with each other. In order to mix the samples with the reagents, the mixed fluid is collected and mixed in the diffluent region 35. The reactive region 36 is in communication with the diffluent region 35, and aligned with the microarray detecting zone 20 of the base layer 2. The specific reaction between the under-test molecule of the sample and the probe molecule 26 occurs at the microarray detecting zone 20, so that the under-test molecule can be detected. Furthermore, the solution outlet 37 is formed in the second surface 32 of the fluid layer 3. The waste solution produced by the specific reaction is exhausted out from the solution outlet 37.

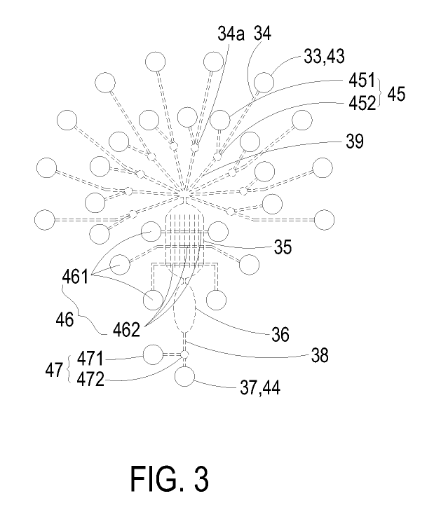

FIG. 3 schematically illustrates the relationships between the fluid layer and the gas regulating layer of the microfluidic chip according to the embodiment of the present invention, in which the gas regulating layer is disposed over the fluid layer. Please refer to FIGS. 1 and 3. In this embodiment, the gas regulating layer 4 is made of polydimethyl siloxane (PDMS). The gas regulating layer 4 comprises a first surface 41 and a second surface 42, wherein the first surface 41 faces the fluid layer 3 and the second surface 42 is opposed to the first surface 41. Moreover, the gas regulating layer 4 comprises plural first slots 43, a second slot 44, plural micro valves 45, and a micropump group 46. The first slots 43 are aligned with respective solution inlets 33 of the fluid layer 3 and in communication with respective solution inlets 33. The second slot 44 is aligned with the solution outlet 37 of the fluid layer 3 and in communication with the solution outlet 37. The plural micro valves 45 may be driven by gases (or a small amount of water), so that the circular membranes 34a of the micro channels 34 are selectively blocked or unblocked. The micropump group 46 may be driven to allow the fluid within the micro channels 34 to be flowed in the direction toward the reactive region 36.

Moreover, each of the plural micro valves 45 is aligned with a corresponding micro channel 34. Each of the plural micro valves 45 comprises a valve pore 451 and a valve chamber 452. The valve pore 451 is formed in the second surface 42 of the gas regulating layer 4. The valve chamber 452 is concavely formed in the first surface 41 of the gas regulating layer 4 and disposed over the corresponding circular membranes 34a of the micro channel 34. The valve pore 451 is connected with a silicone tube and a solenoid valve (not shown). Consequently, a gas may be introduced into the valve chamber 452 through the silicone tube and the valve pore 451. The gas may force the fluid layer 3 underlying the valve chamber 452 to be moved downwardly, so that the circular membranes 34a of the micro channel 34 is compressed to block the fluid within the micro channel 34. On the other hand, once the gas is discharged, the compressed fluid layer 3 is moved upwardly and returned to the original position. Consequently, a negative pressure is generated to facilitate the fluid to flow within the micro channel 34. In other words, the micro valve 45 is opened or closed by selectively charging the gas into the valve chamber 452 or discharging the gas from the valve chamber 452.

Please refer to FIG. 1 again. In this embodiment, the gas regulating layer 4 has a micropump group 46. The micropump group 46 comprises at least three pump pores 461 and at least three pump chambers 462. The pump pores 461 are formed in the second surface 42 of the gas regulating layer 4. The pump chambers 462 are in communication with corresponding pump pores 461. Moreover, the pump chambers 462 are concavely formed in the first surface 41 of the gas regulating layer 4 and disposed over the diffluent region 35. Moreover, each of the pump pores 461 is connected with a silicone tube and a solenoid valve (not shown). Consequently, a gas may be introduced into the corresponding pump chamber 462 through the silicone tube and the pump pore 461, and the gas may force the fluid layer 3 underlying the pump chamber 462 to be moved downwardly, so that the diffluent region 35 is compressed. The three pump chambers 462 of the micropump group 46 are disposed over different segments of the diffluent region 35, and thus, by sequentially and alternately charging the gas into the pump chamber 462 and discharging the gas from the pump chamber 462, the three pump chambers 462 and the diffluent region 35 may cooperate to produce a peristaltic pumping action. Due to the peristaltic pumping action, the fluid is continuously pushed to the reactive region 36, so that the biological detecting reaction is performed at the reactive region 36.

Moreover, the fluid layer 3 further comprises a liquid collecting channel 38. The liquid collecting channel 38 is concavely formed in the first surface 31 of the fluid layer 3. Moreover, the liquid collecting channel 38 is in communication with and arranged between the reactive region 36 and the solution outlet 37. Moreover, the gas regulating layer 4 further comprises a liquid collecting valve 47. The liquid collecting valve 47 is aligned with the collecting channel 38. The liquid collecting valve 47 comprises a valve pore 471 and a valve chamber 472. The valve pore 471 is formed in the second surface 42 of the gas regulating layer 4. The valve chamber 472 is concavely formed in the first surface 41 of the gas regulating layer 4, and disposed over the liquid collecting channel 38. The valve pore 471 is connected with a silicone tube and a solenoid valve (not shown). Consequently, a gas may be introduced into the valve chamber 472 through the silicone tube and the valve pore 471. The gas may force the fluid layer 3 underlying the valve chamber 472 to be moved downwardly, so that the liquid collecting channel 38 is blocked. On the other hand, once the gas is discharged, the compressed fluid layer 3 is moved upwardly and returned to the original position. Meanwhile, a negative pressure is generated to facilitate the fluid to flow to the solution outlet 37 through the liquid collecting channel 38, and thus waste solution produced by the specific reaction is exhausted out from the solution outlet 37. In other words, the liquid collecting valve 47 is opened or closed by selectively charging the gas into the valve chamber 472 or discharging the gas from the valve chamber 472.

In an embodiment, the thickness of the fluid layer 3 is about 42 pm, the depth of the micro channel 34 is about 10 μm˜18 μm, the thickness of the gas regulating layer 4 is about 4 mm, and the depths of the valve chambers 452, 472 and the pump chambers 462 are about 100 μm. The above dimensions are not restricted. It is noted that the numbers and arrangements of the solution inlets 33, the micro channels 34, the second slot 44 and the micropump group 46 may be varied according to the practical requirements.

From the above descriptions, the microfluidic chip of the present invention comprises a base layer, a fluid layer, and a gas regulating layer. The gas regulating layer can control the fluid (e.g. samples, reagents and clearing solutions) to be flowed within the fluid layer. Under this circumstance, a specific reaction between the under-test molecule of the sample and the probe molecule occurs at the microarray detecting zone, so that the under-test molecule can be detected. Moreover, the microarray detecting zone of the base layer comprises a substrate, a photoresist pattern layer, a blocking layer, a bonding layer, a linker molecule, and a probe molecule. Through the bonding layer and the linker molecule, the probe molecule is covalently bonded to the photoresist pattern layer. Consequently, the adhesion between the probe molecule and the photoresist pattern layer is increased, and the stability of the microfluidic chip of the present invention is enhanced. Moreover, the blocking layer of the microfluidic chip of the present invention is formed on the surface of the substrate at the region uncovered by the photoresist pattern layer. Since the blocking layer may block the under-test molecule from being attached thereon through a non-specific reaction, the precision of the microfluidic chip is enhanced. Moreover, the photoresist pattern layer may be produced by a maskless lithography process in order to reduce the fabricating cost and effective minimize the microarray structure of the microfluidic chip. In a case that the photoresist pattern layer is produced by the maskless lithography process, each spot of the microarray structure has a diameter smaller than 300 μm and the fabricating process is simplified. In other words, the microfluidic chip of the present invention has enhanced precision and stability. Moreover, since the fabricating cost is reduced and the fabricating process is simplified, the applications of the microfluidic chip of the present invention are more expansive.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A microfluidic chip, comprising:
a base layer comprising a microarray detecting zone, wherein said microarray detecting zone comprises:
a substrate;
a photoresist pattern layer formed on a surface of said substrate;
a blocking layer formed on said surface of said substrate at a region uncovered by said photoresist pattern layer;
a bonding layer covalently attached to said photoresist pattern layer;
at least one linker molecule covalently bonded to said binding layer; and
a probe molecule covalently bonded to said at least one linker molecule for specifically reacting with an under-test molecule;
a fluid layer disposed over said base layer, and comprising plural flow channels for introducing or collecting detecting reagents; and
a gas regulating layer disposed over said fluid layer for controlling open/close statuses of said flow channels, thereby controlling a flowing condition of a fluid in the fluid layer.

2. The microfluidic chip according to claim 1, wherein said substrate is a glass substrate, a silicon chip substrate or a plastic substrate, and said photoresist pattern layer is made of a SU-8 photoresist material.

3. The microfluidic chip according to claim 1, wherein each spot of said photoresist pattern layer has a diameter of about 10˜300 μm.

4. The microfluidic chip according to claim 1, wherein said blocking layer is made of dimethyldichlorosilane, said bonding layer is made of 3-[Bis(2-hydroxyethl)amino] propyl-triethoxysilane, and said linker molecule is made of 1,4-phenylene diisothiocyanate.

5. The microfluidic chip according to claim 1, wherein said probe molecule is protein or nucleic acid.

6. The microfluidic chip according to claim 1, wherein said fluid layer and said gas regulating layer are made of polydimethyl siloxane.

7. The microfluidic chip according to claim 1, wherein said fluid layer comprises plural solution inlets, plural micro channels, a buffer region, a diffluent region, a reactive region, and a solution outlet.

8. The microfluidic chip according to claim 1, wherein said gas regulating layer comprises plural first slots, a second slot, plural micro valves, and a micropump group.

9. The microfluidic chip according to claim 8, wherein each of said plural micro valves comprises a valve pore and a valve chamber.

10. The microfluidic chip according to claim 8, wherein said micropump group comprises at least three pump pores and at least three pump chambers.
